(19) United States
(12) Patent Application Publication
(10) Pub. No.: US 2023/0236587 A1
(43) Pub. Date: Jul. 27, 2023

(54) DATA FUSION AND RECONSTRUCTION METHOD FOR FINE CHEMICAL INDUSTRY SAFETY PRODUCTION BASED ON VIRTUAL KNOWLEDGE GRAPH

(71) Applicant: DALIAN UNIVERSITY OF TECHNOLOGY, Dalian (CN)

(72) Inventors: Xin YANG, Dalian (CN); Xiaopeng WEI, Dalian (CN); Li ZHU, Dalian (CN); Xirong XU, Dalian (CN); Zitao YIN, Dalian (CN)

(21) Appl. No.: 17/992,791

(22) Filed: Nov. 22, 2022

(30) Foreign Application Priority Data
Jan. 27, 2022 (CN) 202210099893.4

(51) Int. Cl. G05B 23/02

(52) U.S. Cl. CPC G05B 23/0229; G05B 23/027; G05B 2223/02

(57) ABSTRACT

The present invention provides a data fusion and reconstruction method for fine chemical industry safety production based on a virtual knowledge graph. In view of the characteristics of fine chemical industry safety production data, such as a large amount of structured data, a multi-source heterogeneous database and a strong sequential logic, the present invention innovatively proposes a method of using a virtual knowledge graph to complete the fusion and reconstruction of a traditional database for fine chemical industry. The present invention fuses static structured knowledge in the field of fine chemical industry with a real-time dynamic database for chemical industry safety production in the concept of ontologies for the first time to organize time series data in the form of entities. In addition, the mapping rules of the existing OBDA system are improved based on a data set of the present invention.

### TECHNICAL FIELD

The present invention belongs to the field of knowledge extraction of knowledge graphs. Facing to a large number of structured databases and multi-source heterogeneous knowledge data tables for fine chemical industry safety production, the present invention provides a data fusion and reconstruction method based on a virtual knowledge graph, thus to open up the knowledge data silos of chemical industry enterprises, encapsulate a database structure by “Blackbox”, and conduct data fusion and reconstruction on a concept level of ontologies.

### BACKGROUND

### (1) Current Status of Fine Chemical Industry Safety Production Data

Safety production data of fine chemicals has the characteristics of diversified sources, complicated structure and difficult access. First, the diversified sources include instrument measurement, image monitoring, fault database, fault tracking report, safety check report, safety state analysis, etc., which are widely present in production, quality, inventory, maintenance, energy consumption and other links; second, the structure of traditional databases and data tables of fine chemical industry is complicated and diversified without unified semantic expression, so the phenomenon of data silos is serious; third, when a user access an existing database system, a lot of database technology and underlying physical storage knowledge are needed as support, so the user friendliness is low.

### (2) Virtual Knowledge Graph

Virtual knowledge graph is a database reconstruction technology that reconstructs a database into a virtual knowledge graph view when the database is accessed and disappears when the access is ended. The essence of the virtual knowledge graph is knowledge extraction oriented to structured data, which is to map a large amount of heterogeneous structured data from a traditional relational database onto a virtual ontology-based concept view. The virtual knowledge graph is an improvement on a traditional OBDA system with respect to a time series database, wherein a typical OBDA system is composed of an ontology part, a data source part and a mapping part, and can be expressed in the form of a triple O=<T, S, M>.

T is also called TBox, which describes the definitions and logical relations of nodes and edges in a graph database.

S represents the traditional relational database, which is defined in the fine chemical industry as databases (such as DCS) and some static structured safety knowledge tables.

M is short for Mapping and is represented as Q(S)→Q(O), where Q(S) represents a query on the traditional relational database and returns a relational view on S. Q(O) represents a query on the knowledge graph and returns a subgraph in a graph O.

Different from the traditional OBDA system which only contains a static database, a structured database for fine chemical industry is a combination of a static database and a dynamic database. Mapping rules need to be updated in real time to generate a dynamic data view based on the virtual knowledge graph in real time.

In this view, isolated databases of fine chemical industry are united and reconstructed into an ontology graph which is more in line with human thinking, so as to “virtually exist” independently of an underlying heterogeneous database. At present, some standards and tools are available to support the conversion of traditional database data into RDF data, OWL ontologies, etc. of a knowledge graph. W3C's RDB2RDF working group has published two recommended RDB2RDF mapping languages in 2012: DM (Direct Mapping) and R2RML, both of which are used to define various rules for converting data in a relational database into RDF data, specifically comprising generation of URI, definition of RDF classes and attributes, processing of empty nodes, expression of association relation between data, etc.

Based on a large number of multi-source heterogeneous structured databases and data tables in a fine chemical industry safety production process, the present invention discovers the structural characteristics of data and the form of data organization, proposes a fusion and reconstruction method for structured databases based on the virtual knowledge graph, opens up the structured data in fine chemical industry safety production, and achieves graph-form reconstruction of an underlying database.

### SUMMARY

In view of the characteristics of fine chemical industry safety production data, such as a large amount of structured data, a multi-source heterogeneous database and a strong sequential logic, the purpose of the present invention is to innovatively propose a method of using a virtual knowledge graph to complete the fusion and reconstruction of a traditional database for fine chemical industry. Specifically, a database is reconstructed from a perspective closer to human logic without increasing the storage scale of an original database, thus making the logic mode and storage mode of an underlying database independent, and making a multi-source database easier and clearer to access.

The technical solution of the present invention is as follows:

A data fusion and reconstruction method for fine chemical industry safety production based on a virtual knowledge graph, comprising the following steps:

Step 1: constructing a structured knowledge data set for fine chemical industry safety production

The structured knowledge data set for fine chemical industry safety production is mainly from the following two aspects, and can be replanned by an organization using the technology according to the database access requirements of the organization and the physical organizing form of underlying data;

(1) Dynamically changing real-time database

The dynamically changing real-time database is mainly composed of a time series data set from a sensor and a shift log set from an operator;

\textcircled{1} The time series data set from a sensor

Real-time changing monitoring data collected by a sensor is centrally processed by a DCS (Distributed Control System) and stored in a DCS database, and then distributed to other data application systems on top of the DCS database, thus to achieve on-demand access to the monitoring data;

\textcircled{2} The shift log set from an operator

The shift log set from an operator comprises three aspects of data: shift taking over situation, current shift situation and shift handing over situation, which are entered into a PMCI database by a person in charge; the three aspects of data includes four kinds of data, i.e., a data record of main detection sites at a shift change moment, an operator's operation record, a material getting in and out record, and a material handing over record; the same as the data at monitoring sample points of the DCS, shift log data also has a high degree of temporality and dynamic change.

(2) Statically stored relational data table

The statically stored relational data table is mainly composed of a main production equipment table, a fine chemicals database, an alarm risk analysis & control measure table, and an SIS interlocking control scheme table;

\textcircled{1} The main production equipment table comprises equipment, bit numbers, and temperature and pressure ranges of the equipment;

\textcircled{2} The fine chemicals database comprises a substance identification and classification table, a hazardous chemicals identification table, and a main hazardous chemicals physical and chemical property data table; such data comes from laws, regulations and industry standards, and is an effective supplement to monitoring site data of the DCS database, but the two kinds of data are not organically combined at present.

\textcircled{3} The alarm risk analysis & control measure table is divided into a DCS alarm analysis & control measure set and an SIS alarm analysis & control measure set, mainly describing normal operation values, alarm thresholds and post-alarm processing measures at detection sites;

\textcircled{4} The SIS interlocking control scheme table is exported from a safety interlocking system which is a system that can achieve one or more safety functions and is used for monitoring the operation of a production device or individual unit; if a production process exceeds a safe operation range, the safety interlocking system will make the production device or individual unit enter a safe state to ensure the safety thereof; the safety interlocking system is a logic operation set based on PID control, while the SIS interlocking control scheme table is an integration of such control logics and rules, and is used for representing an interconnection relation based on safety production between the equipment and the bit numbers;

Step 2: constructing an OWL2 QL ontology set

First, as fine chemical industry is a typical process technology industry, safety production data are mostly processed and responded based on data collected by sensors. Second, a virtual knowledge graph is a sub-view containing time series data, which is formed based on a physically stored database, and is closer to human thinking; the virtual knowledge graph is convenient for a working staff to quickly obtain data as well as associated safety production knowledge and rules without the knowledge of the underlying database and other data tables.

OWL2 QL language is used to build ontologies, which has the following characteristics:

\textcircled{1} The language design is simple, which is convenient for designing an ontology hierarchy of a multi-source heterogeneous database;
\textcircled{2} The query complexity is AC⁰, which is very suitable for large-scale data, and is more suitable for DCS database data access and processing.

(1) Determining Ontologies

An ontology hierarchy with a gradient structure including top-level ontologies and lower-level ontologies is constructed by combing the characteristics of the data sets; wherein

The top-level ontologies include various real-time dynamic databases or static knowledge data tables; and

The lower-level ontologies include non-attribute fields of various structured databases;

(2) Determining Ontology Relations
The relations between the top-level ontologies and the lower-level ontologies are as follows:
The lower-level ontologies are a subclass of the top-level ontologies and inherit all attributes of the top-level ontologies;

Relations and attributes of the lower-level ontologies can be inherited by all entities under the lower-level ontologies, and the entities are specifically represented in the data set as records of a dynamic time series database or a static knowledge database at each moment;

Step 3: designing R2RML mapping rules

Under the lower-level ontologies, a specific structured record is taken as an entity. The DCS is taken as a core database to be associated with other databases or data tables, and each monitoring site of the DCS is taken as a primary key. The essence of this process is to associate physical quantities monitored at sensor sites with other knowledge databases (such as a hazardous chemicals database, production equipment table monitoring sites, and the alarm risk analysis & control measure table). When the staff access a database on demand, the staff only need to enter required query conditions, such as time and content of the physical quantities monitored, and then a reconstructed “virtual” database graph view that fuses other relevant knowledge bases can be obtained.

RDF is a resource description framework, which is composed of <a subject, a predicate and an object> and supported by ontology theory, and is closer to human thinking.

Different from a traditional DM mapping language, a R2RML mapping language can be used to dynamically generate required RDF data according to a user's requirements, then merge the same subjects and objects in the RDF data into graph nodes in a graph structure view, and finally form a graph structure view. As the process involves only the part of the data that the user needs to access, the method is a partial reconstruction achieved on a source database, rather than a full replication. For a large amount of structured data in fine chemical industry safety production, especially time series data generated by continuous iteration, the R2RML language is adopted, and “time constraints” are added on the basis of the original R2RML language, i.e., monitoring data within a certain time period or a time period taking a certain event as a node is invoked according to the user's requirements, and knowledge data of other associated databases is returned to the user.

A custom mapping language of R2RML is adopted and improved, and improved mapping rules are as follows:

\textcircled{1} Tables of the databases are mapped into an RDF class of top-level ontologies;

\textcircled{2} In column fields of the tables of the databases: data of a literal or symbol class (such as a fault cause, a fault consequence and a monitoring site) is mapped into an RDF class of lower-level ontologies;

\textcircled{3} In column fields of the tables of the databases: data of a numeric class (such as a temperature limit, a pressure limit and a normal operating value) is defined as an attribute of primary keys of the row;

\textcircled{4} In each row of each field of the tables of the databases: data of a literal or symbol class is defined as an entity;

\textcircled{5} In each row of each field of the tables of the databases except the DCS database: data of a numeric class is defined as an attribute of primary keys of the row;

\textcircled{6} Data under each site at each moment of the DCS database is taken as an entity;

\textcircled{7} If a cell is a literal or symbol class of data, and is corresponding to a foreign key of the tables of the other databases, the cell is replaced with the entity to which the value of the foreign key is pointed;

i.e., one subject mapping and multiple predicate-object mappings; the subject mapping is to generate the subjects of all RDF triples from a logic table, i.e., to select the primary keys as the subjects of the triples; and the predicate-object mappings include a predicate mapping and an object mapping.

The present invention has the following beneficial effects:

(1) Innovation of method

The present invention fuses static structured knowledge in the field of fine chemical industry with a real-time dynamic database for chemical industry safety production in the concept of ontologies for the first time to organize time series data in the form of entities. In addition, the mapping rules of the existing OBDA system are improved based on a data set of the present invention.

(2) Storage overhead of virtual knowledge graph

The essence of a virtual knowledge graph is a graph structure view reconstructed based on an original structured database after linking. The virtual knowledge graph occupies no physical storage space, presents only when a user accesses a database, and disappears after the access is ended. The virtual knowledge graph has the following benefits: first, the virtual knowledge graph is convenient to develop; when an application of the virtual knowledge graph is developed, it is not needed to rebuild a database, but only needed to change the forms of data access and organization. Second, data safety is ensured; when the user accesses the database, only the data required by the user is involved, and not all the data is shown to the user. In addition, compared with a graph database, the virtual knowledge graph will not generate an extra copy of an original relational database, which greatly improves the safety of the data.

(3) Broad prospect

A knowledge graph is a data organization technology arisen in various application scenarios, and has a great referential significance for a new generation of artificial intelligence. In addition, the knowledge graph can fuse a large amount of multi-source heterogeneous data, so as to complete various application tasks such as prediction, reasoning and question answering based on big data. In the field of fine chemical industry, the virtual knowledge graph formed by structured data can also be combined with text information, plant monitoring information as well as audio and video monitoring information of equipment to deeply understand the semantics thereof and conduct further application research.

### DESCRIPTION OF DRAWINGS

FIG. 1 is an architecture diagram of constructing a virtual knowledge graph for fine chemical industry safety production.

FIG. 2 is an ontology hierarchy design diagram of a virtual knowledge graph.

FIG. 3 is an example of a virtual graph of a DCS database at a single site and a single moment.

### DETAILED DESCRIPTION

Specific embodiments of the present invention are further described below in combination with accompanying drawings and the technical solution.

The data used in the present invention is common structured data of fine chemical industry, but the problem faced is the production safety of fine chemical industry, instead of all structured data. Therefore, based on this problem, six data sources including real-time dynamically changing structured data and static knowledge data tables are collected and sorted. The data is organized in the form of a traditional relational database and presented to the user in the form of a data table view as shown below.

DCS database

| Time | TA001 | PA001 | LA001 |
|---|---|---|---|
| Dec. 1, 2021 08:00:00 | 50 | 60 | 70 |

Shift log

| | | Person | | | | |
|---|---|---|---|---|---|---|
| | Shift | handing | | | | Person |
| Shift handing | handing over | over | Current shift | Shift taking | Shift taking | taking over |
| over time | situation | the shift | situation | over time | over situation | the shift |
| 2021/12/01 | TA001 = 51 | A | Opening | 2021/12/01 | TA001 = 55 | B |
| 08:15:00 | PA001 = 61 | | valve 1 | 09:15:00 | PA001 = 65 | |
| | LA001 = 71 | | Charging | | LA001 = 75 | |
| | | | through | | | |
| | | | port 2 | | | |

Production equipment table

| | | | | DCS | DCS bit number |
|---|---|---|---|---|---|
| Equipment | Equipment | Temperature | Pressure | bit | measurement |
| number | name | limit | limit | number | substance |
| R-101 | Reactor | 60 | 200 | TA001 | CHE1 |
| | | | | PA001 | CHE1 |
| | | | | LA001 | CHE1 |

Chemicals table

| | CAS | UN | Melting | Boiling | Combustion | Ignition |
|---|---|---|---|---|---|---|
| Name | number | number | point | point | limit | temperature |
| CHE1 | — | — | — | — | — | — |

Alarm risk analysis & control measure table

| | | Normal | | | | |
|---|---|---|---|---|---|---|
| Bit | | operation | Low | Fault | Fault | Accident |
| number | Description | value | alarm | cause | consequence | treatment |
| TA001 | R-101 inlet | 40-100 | — | — | — | — |
| | temperature | | | | | |

SIS data table

| | LL | HH | |
|---|---|---|---|
| Bit | interlocking | interlocking | Interlocking |
| number | value | value | result |
| LA001 | −10 | 150 | TRIP Alarm |

The core of a fine chemical industry safety production problem includes sensor data real-time monitoring, abnormal alarm, fault tracing and alarm treatment schemes. Based on this, the OWL2 QL language is used for ontology modeling for the first time, and the ontologies are divided into the top-level ontologies and the lower-level ontologies. The table name of each data source serves as a top-level ontology, and the field names below the table name serve as the lower-level ontologies or attributes.

Taking one row of data in the DCS database (i.e., the data of 3 sensors at 1 time point, and the alarm risk analysis & control measure table) as an example, the following is a triple representation method of the two classes of data.

<http://data.FineChemicalSafetyProduction.com/DCS/2021.12.01.08.00.00> rdf: type ex: TIME.

<http://data.FineChemicalSafetyProduction.com/DCS/50> rdf: type ex: TA001.

<http://data.FineChemicalSafetyProduction.com/DCS/60> rdf: type ex: PA001.

<http://data.FineChemicalSafetyProduction.com/DCS/70> rdf: type ex: LA001.

<http://data.FineChemicalSafetyProduction.com/DCS/2021.12.01.08.00.00> ex: TA001 is “50”.

<http://data.FineChemicalSafetyProduction.com/DCS/2021.12.01.08.00.00> ex: PA001 is “60”.

<http://data.FineChemicalSafetyProduction.com/DCS/2021.12.01.08.00.00> ex: LA001 is “100”.

<http://data.FineChemicalSafetyProduction.com/DCS/50> ex: AlarmRiskAnalysis

<http://data.FineChemicalSafetyProduction.com/AlarmRiskAnalysis/LA001>

<http://data.FineChemicalSafetyProduction.com/AlarmRiskAnalysis/LA001> rdf: type ex: TagNumber.

<http://data.FineChemicalSafetyProduction.com/AlarmRiskAnalysis/LA001> ex: Describe “Inlet Temperature and Pressure”.

<http://data.FineChemicalSafetyProduction.com/AlarmRiskAnalysis/LA001> ex: NormalOperatingValue “40-100”.

In order to convert traditional structured time series data and tables into the above RDF triple data, two mapping documents need to be created, i.e., a mapping document for single data tables and a mapping document for linkage of multiple data tables.

Taking the DCS database as an example, an R2RML mapping document for single data tables is shown below:

```
<#TriplesMap1>
  rr: logicalTable <#DcsTableView>;
  rr: subjectMap [
    rr:template
“http://data.FineChemicalSafetyProduction.com/DCS/
{2021.12.01.08.00.00}”;
    rr: class ex: TIME;
  ];
  rr: predicateObjectMap [
    rr: predicate ex: TA001is;
    rr: objectMap [rr: column “TA001”];
  ];
  rr: predicateObjectMap [
    rr: predicate ex: LA001is;
    rr: objectMap [rr: column “LA001”];
  ];
  rr: predicateObjectMap [
    rr: predicate ex: PA001is;
    rr: objectMap [rr: column “PA001”];
  ].
```

Taking a linking view of the DCS database and the alarm risk analysis & control measure table as an example, an R2RML mapping document for linkage of multiple data tables is shown below:

```
<#TriplesMap2>
rr: predicateObjectMap [
  rr: predicate ex: LA001;
    rr: objectMap [
    rr: parentTriplesMap <#TriplesMap2>;
      rr: joinCondition [
        rr: child “LA001”;
        rr: parent “LA001”;];
    ];
].
```

Then, the structured database for fine chemical industry is started, and OWL documents of the ontologies and the R2RML mapping documents are accessed to an OBDA system through an API interface. The mapping rules will have different encodes in different OBDA systems. For example, if an Ontop tool is used to access the DCS data of on certain day, a dynamic virtual ontology (i.e., the TA001 data on the same day) need to be added in addition to the above basic mapping rules, and dynamic mapping rules are as follows:

mappingId dcs-today's TA001

target: Safety in production/dcs/{TA001} a: dcs-today's TA001.

source SELECT TIME, TA001 FROM “DCS”
WHERE “TIME” (Time condition screening)

Finally, satisfactory triple data is returned by query results, and is presented in the form of a virtual view.

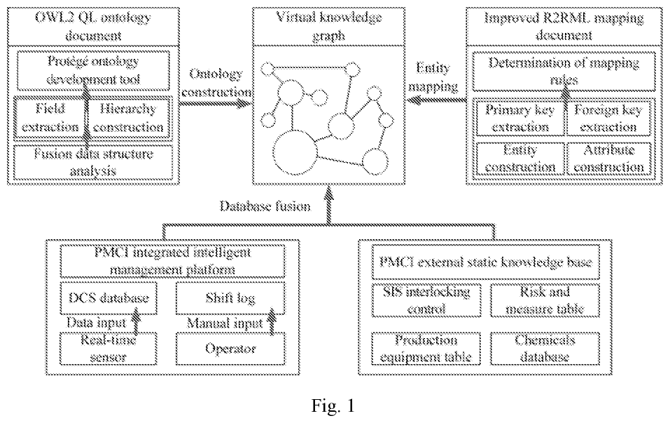

FIG. 1 is an architecture diagram of constructing a virtual knowledge graph for fine chemical industry safety production. The diagram is divided into three modules, i.e., an underlying data collection module, an OWL ontology design module and an R2RML mapping rule design module. Original underlying data is independent of each other, an OWL language and a Protégé ontology development tool are used for ontology modeling, and data with the same meaning is taken as one ontology to fuse the multi-source database. Each row of data in the database is mapped into entities under each ontology by a R2RML mapping sector, and then primary keys and foreign keys of the entities are selected from the structured database to complete the construction of the mapping rules.

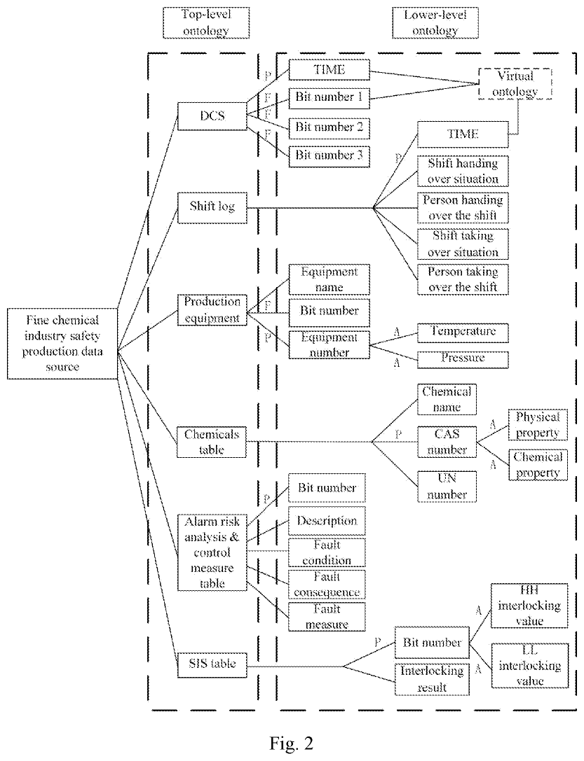

FIG. 2 is an ontology hierarchy design diagram of the present invention. By sorting out the database structure designed by the present invention, the ontology hierarchy is divided by a top-down method. The table names of the data tables are extracted to serve as a top-level ontology, the non-attribute fields of the data tables are extracted to serve as a lower-level ontology, and the attribute fields are extracted to serve as the attributes of the entities. When a user needs to access a database on demand, a virtual ontology will be created by the mapping language to organize the data of relevant entities, and will be revoked after the access is ended.

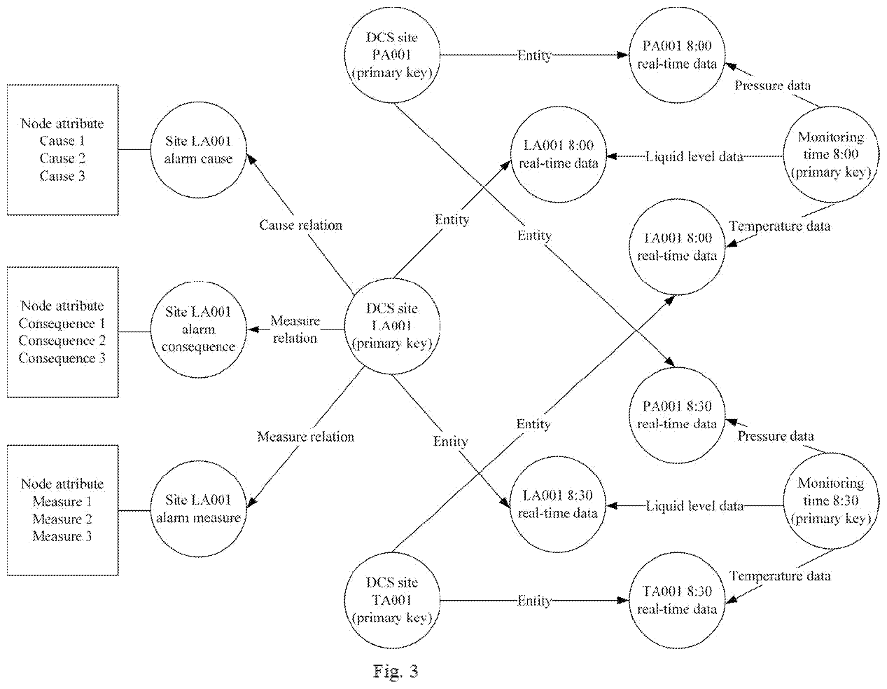

FIG. 3 is an example of a concept graph constructed based on alarm risk analysis and control measures of 3 monitoring sites and 1 site at 2 time points of the DCS by defining the data as nodes in a virtual view and defining the logical relation between the nodes. The figure shows the logical relation of the virtual knowledge graph, i.e., the association relation between the real-time dynamically changing database data and the static knowledge base data is constructed, and the virtual view which is based on the ontologies and associated with the multi-source database is returned to the user.

1. A data fusion and reconstruction method for fine chemical industry safety production based on a virtual knowledge graph, comprising the following steps:
step 1: constructing a structured knowledge data set for fine chemical industry safety production
the structured knowledge data set for fine chemical industry safety production is mainly from the following two aspects:
(4) dynamically changing real-time database
the dynamically changing real-time database is mainly composed of a time series data set from a sensor and a shift log set from an operator;
\textcircled{1} the time series data set from a sensor
real-time changing monitoring data collected by a sensor is centrally processed by a DCS (Distributed Control System) and stored in a DCS database, and then distributed to other data application systems on top of the DCS database, thus to achieve on-demand access to the monitoring data;
\textcircled{2} the shift log set from an operator
the shift log set from an operator comprises three aspects of data: shift taking over situation, current shift situation and shift handing over situation, which are entered into a PMCI database by a person in charge; the three aspects of data includes four kinds of data, i.e., a data record of main detection sites at a shift change moment, an operator's operation record, a material getting in and out record, and a material handing over record;
(5) statically stored relational data table
the statically stored relational data table is mainly composed of a main production equipment table, a fine chemicals database, an alarm risk analysis and control measure table, and an SIS interlocking control scheme table;
\textcircled{1} the main production equipment table comprises equipment, bit numbers, and temperature and pressure ranges of the equipment;
\textcircled{2} the fine chemicals database comprises a substance identification and classification table, a hazardous chemicals identification table, and a main hazardous chemicals physical and chemical property data table;
\textcircled{3} the alarm risk analysis and control measure table is divided into a DCS alarm analysis and control measure set and an SIS alarm analysis and control measure set, mainly describing normal operation values, alarm thresholds and post-alarm processing measures at detection sites;
\textcircled{4} the SIS interlocking control scheme table is exported from a safety interlocking system which is a system that can achieve one or more safety functions and is used for monitoring the operation of a production device or individual unit; if a production process exceeds a safe operation range, the safety interlocking system will make the production device or individual unit enter a safe state to ensure the safety thereof; the safety interlocking system is a logic operation set based on PID control, while the SIS interlocking control scheme table is an integration of such control logics and rules, and is used for representing an interconnection relation based on safety production between the equipment and the bit numbers;
step 2: constructing an OWL2 QL ontology set
(1) determining ontologies
an ontology hierarchy with a gradient structure including top-level ontologies and lower-level ontologies is constructed; wherein
the top-level ontologies include various real-time dynamic databases or static knowledge data tables; and
the lower-level ontologies include non-attribute fields of various structured databases;
(2) determining ontology relations
the relations between the top-level ontologies and the lower-level ontologies are as follows:
the lower-level ontologies are a subclass of the top-level ontologies and inherit all attributes of the top-level ontologies;
relations and attributes of the lower-level ontologies can be inherited by all entities under the lower-level ontologies, and the entities are specifically represented in the data set as records of a dynamic time series database or a static knowledge database at each moment;
step 3: designing R2RML mapping rules
under the lower-level ontologies, a specific structured record is taken as an entity, the DCS is taken as a core database to be associated with other databases or data tables, and each monitoring site of the DCS is taken as a primary key;
a R2RML mapping language is used to dynamically generate required RDF data according to a user's requirements, then merge the same subjects and objects in the RDF data into graph nodes in a graph view, and finally form a graph structure view; as the process involves only the part of the data that the user needs to access, the method is a partial reconstruction achieved on a source database, rather than a full replication. for a large amount of structured data in fine chemical industry safety production, especially time series data generated by continuous iteration, the R2RML language is adopted, and “time constraints” are added on the basis of the original R2RML language, i.e., monitoring data within a certain time period or a time period taking a certain event as a node is invoked according to the user's requirements, and knowledge data of other associated databases is returned to the user;
direct mapping rules of DM are as follows:
\textcircled{1} tables of the databases are mapped into RDF classes;
\textcircled{2} columns in the tables of the databases are mapped into RDF attributes;
\textcircled{3} each row in the tables of the databases is mapped into a triple entity, creating an IRI; and
\textcircled{4} value of each cell in the tables of the databases is mapped into a literal value; if the value of the cell is corresponding to a foreign key, the value is replaced with the IRI of the resource or entity to which the value of the foreign key is pointed;
a custom mapping language of R2RML is adopted and improved, and improved mapping rules are as follows:
\textcircled{1} tables of the databases are mapped into an RDF class of top-level ontologies;
\textcircled{2} in column fields of the tables of the databases: data of a literal or symbol class is mapped into an RDF class of lower-level ontologies;
\textcircled{3} in column fields of the tables of the databases: data of a numeric class is defined as an attribute of primary keys of the row;
\textcircled{4} in each row of each field of the tables of the databases: data of a literal or symbol class is defined as an entity;
\textcircled{5} in each row of each field of the tables of the databases except the DCS database: data of a numeric class is defined as an attribute of primary keys of the row;
\textcircled{6} data under each site at each moment of the DCS database is taken as an entity;
\textcircled{7} if a cell is a literal or symbol class of data, and is corresponding to a foreign key of the tables of the other databases, the cell is replaced with the entity to which the value of the foreign key is pointed;
i.e., one subject mapping and multiple predicate-object mappings; the subject mapping is to generate the subjects of all RDF triples from a logic table, i.e., to select the primary keys as the subjects of the triples; and the predicate-object mappings include a predicate mapping and an object mapping.
